(19) United States
(12) Patent Application Publication
(10) Pub. No.: US 2020/0025160 A1
(43) Pub. Date: Jan. 23, 2020

(54) ENGINE SYSTEM

(71) Applicant: AISAN KOGYO KABUSHIKI KAISHA, Obu-shi (JP)

(72) Inventors: Takehide Nakamura, Handa-shi (JP); Masanori ITO, Inazawa-shi (JP)

(21) Appl. No.: 16/509,848

(22) Filed: Jul. 12, 2019

(30) Foreign Application Priority Data
Jul. 23, 2018 (JP) 2018-137976

(51) Int. Cl. F02M 26/35; F02M 26/30; F02M 26/34; F02M 26/09

(52) U.S. Cl. CPC F02M 26/35; F02M 26/30; F02M 2026/001; F02M 26/09; F02M 26/34

(57) ABSTRACT

An engine system including a drainage passage connected to a third portion of an intake passage that is on a downstream side relative to a supercharger and on an upstream side relative to a throttle valve; a drainage valve configured to open and close the drainage passage; an exhaust bypass passage connected to a first portion of the exhaust passage and a fourth portion of the exhaust passage on upstream side relative to the supercharger, and provided to deliver gas flowing in the fourth portion of the exhaust passage to the first portion of the exhaust passage; a wastegate valve configured to adjust a passage area of the exhaust bypass passage; and a controller. The controller may be configured to reduce an opening degree of the wastegate valve, reduce an opening degree of a throttle valve, and open the drainage valve.

### CROSS-REFERENCE TO RELATED APPLICATION

This application claims priority to Japanese Patent Application No. 2018-137976, filed on Jul. 23, 2018, the entire contents of which are incorporated herein by reference.

### TECHNICAL FIELD

The technique disclosed herein relates to an engine system.

### BACKGROUND

A device described in Patent Document 1 (Japanese Patent Application Publication No. 2014-074356) is provided with an engine, an intake passage through which air to be suctioned into the engine flows, an exhaust passage through which gas discharged from the engine flows, and a supercharger provided across the intake passage and the exhaust passage. The supercharger is configured to be operated by a pressure of the gas flowing through the exhaust passage to pump the air flowing through the intake passage to the engine. The device of Patent Document 1 is further provided with an EGR passage connected to the intake passage and a portion of the exhaust passage that is on upstream side relative to the supercharger. The supercharger used in the device of Patent Document 1 is electrically driven to increase a supercharging pressure. The device of Patent Document 1 is further provided with a throttle valve provided in a portion of the intake passage on downstream side relative to the supercharger and configured to adjust a passage area of the intake passage, and a drainage passage connected to a portion of the intake passage that is on the downstream side relative to the supercharger and on upstream side relative to the throttle valve.

In the device of Patent Document 1, condensed water may be generated within the intake passage when the air and EGR gas flowing through the intake passage are cooled. In this case, a condensed water discharging control is executed. In the condensed water discharging control, an ECU causes the electrically driven supercharger to operate while the throttle valve is closed. Due to this, a pressure in the intake passage increases, and the condensed water generated in the intake passage is discharged through the drainage passage by the increased pressure.

### SUMMARY

The electrically driven supercharger is used in the device of Patent Document 1. In this device, the electrically driven supercharger is caused to operate in the condensed water discharging control, thus power consumption increases. In view of this, the disclosure herein provides a technique that can discharge condensed water without increasing power consumption.

An engine system disclosed herein may comprise: an engine; an intake passage through which air to be suctioned into the engine flows; an exhaust passage through which gas discharged from the engine flows; a supercharger provided across the intake passage and the exhaust passage, and configured to be operated by a pressure of gas flowing through the exhaust passage to pump air flowing through the intake passage to the engine; an exhaust recirculation passage connected to the intake passage and a first portion of the exhaust passage that is on downstream side relative to the supercharger, and provided to deliver gas flowing in the first portion of the exhaust passage to the intake passage; a throttle valve provided in a second portion of the intake passage on downstream side relative to the supercharger, and configured to adjust a passage area of the second portion of the intake passage; a drainage passage connected to a third portion of the intake passage that is on the downstream side relative to the supercharger and on upstream side relative to the throttle valve; a drainage valve configured to open and close the drainage passage; an exhaust bypass passage connected to the first portion of the exhaust passage and a fourth portion of the exhaust passage on upstream side relative to the supercharger, and provided to deliver gas flowing in the fourth portion of the exhaust passage to the first portion of the exhaust passage; a wastegate valve configured to adjust a passage area of the exhaust bypass passage; and a controller. The controller may be configured to reduce an opening degree of the wastegate valve, reduce an opening degree of the throttle valve, and open the drainage valve.

In the above configuration, condensed water may be generated in the intake passage when the air and EGR gas flowing through the intake passage are cooled. When this happens, in the above configuration, the controller reduces the opening degree of the wastegate valve and reduces the opening degree of the throttle valve. A flow rate of the gas flowing through the exhaust bypass passage decreases when the controller reduces the opening degree of the wastegate valve. Due to this, a flow rate of the gas flowing into the exhaust bypass passage from the exhaust passage decreases, whereas a flow rate of the gas passing through the supercharger provided on the exhaust passage increases. As a result, a pressure of the gas for operating the supercharger increases, and a pressure with which the supercharger pumps the air flowing through the intake passage increases accordingly.

The above configuration includes the exhaust recirculation passage connected to the intake passage and the first portion of the exhaust passage that is on the downstream side relative to the supercharger. The above configuration is a so-called LPL-EGR (Low Pressure Loop-Exhaust Gas Recirculation) configuration that feeds the gas flowing through the first portion of the exhaust passage on the downstream side relative to the supercharger to the intake passage through the exhaust recirculation passage. In the LPL-EGR configuration, the exhaust recirculation passage is connected to the first portion of the exhaust passage, thus the flow rate of gas passing through the supercharger in the exhaust passage increases as compared to a conventional HPL-EGR (High Pressure Loop-Exhaust Gas Recirculation) configuration in which the exhaust recirculation passage is connected to a portion of the exhaust passage on the upstream side relative to the supercharger. Since the pressure of the gas passing through the supercharger can sufficiently operate the supercharger, the supercharger does not need to be electrically driven. Thus, extra power to drive the supercharger is not consumed.

Further, in the above configuration, a pressure in the third portion of the intake passage that is on the downstream side relative to the supercharger and on the upstream side relative to the throttle valve increases when the controller reduces the opening degree of the throttle valve. When this happens, a pressure in the drainage passage connected to the third portion of the intake passage increases. As a result, the increased pressure pushes condensed water generated in the intake passage out from the intake passage and the condensed water is discharged through the drainage passage. As such, according to the above configuration, the condensed water can be discharged without increasing power consumption.

Further, in the above LPL-EGR configuration, a temperature of the gas fed from the exhaust passage to the intake passage through the exhaust recirculation passage is low as compared to the conventional HPL-EGR configuration, thus a larger amount of condensed water may be generated in the intake passage. In such a case, the above configuration, which is capable of discharging the condensed water without increasing power consumption, is particularly effective.

The above engine system may further comprise a flow rate detector configured to detect a flow rate of air flowing through the intake passage. The controller may be configured to determine a timing to close the drainage valve and determine whether condensed water generated in the intake passage has been discharged through the drainage passage, based on the flow rate detected by the flow rate detector.

According to this configuration, the timing to close the drainage valve can be determined with a simple configuration. Further, whether or not the condensed water generated in the intake passage has been discharged through the drainage passage can be determined with a simple configuration.

The above engine system may further comprise an intercooler provided on the third portion of the intake passage. The drainage passage may be connected to a portion of the intake passage that is on the downstream side relative to the supercharger and on upstream side relative to the intercooler.

In the portion of the intake passage on the upstream side relative to the intercooler, hot air and EGR gas, which has passed through the supercharger, are rapidly cooled in advance of the intercooler, thus a large amount of condensed water may be generated there. Due to this, the large amount of condensed water may collect in the portion of the intake passage on the upstream side relative to the intercooler. According to the above configuration, the condensed water collecting in the portion of the intake passage on the upstream side relative to the intercooler can be discharged.

The intercooler may be provided at a position higher than a position of the supercharger. The intake passage may comprise a rising portion at the portion thereof that is on the downstream side relative to the supercharger and on the upstream side relative to the intercooler, and the rising portion may rise from a supercharger side to an intercooler side. The drainage passage may be connected to a portion of the intake passage on upstream side relative to the rising portion.

In the engine system, due to a structural reason of the engine, the intercooler may be provided at a position higher than the supercharger. In this case, the intake passage is provided with the rising portion, which rises from the supercharger side to the intercooler side, at the portion of the intake passage on the downstream side relative to the supercharger and on the upstream side relative to the intercooler. In this configuration, condensed water generated in the portion of the intake passage on the upstream side relative to the intercooler may flow downward through the rising portion and collect on the upstream side relative to the rising portion. According to the above configuration, the drainage passage is connected to the portion of the intake passage on the upstream side relative to the rising portion, thus the condensed water collecting on the upstream side relative to the rising portion can be discharged.

The engine system may further comprise an intercooler provided on the third portion of the intake passage. The drainage passage may be connected to a portion of the intake passage that is on downstream side relative to the intercooler and on the upstream side relative to the throttle valve.

In the engine system provided with the intercooler, air and EGR gas are cooled by the intercooler, which may result in a large amount of condensed water generated in the portion of the intake passage on the downstream side relative to the intercooler. As a result, the condensed water may collect in the portion of the intake passage on the downstream side relative to the intercooler. According to the above configuration, the condensed water collecting in the portion of the intake passage on the downstream side relative to the intercooler can be discharged.

### BRIEF DESCRIPTION OF DRAWINGS

FIG. 1 is a diagram schematically showing an engine system of an embodiment.

FIG. 2 is a flowchart of a condensed water discharging process of the embodiment.

FIG. 3 is a graph showing an example of a flow rate detected by an air flow meter.

FIG. 4 is a diagram schematically showing an engine system of another embodiment.

### DETAILED DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved engine systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

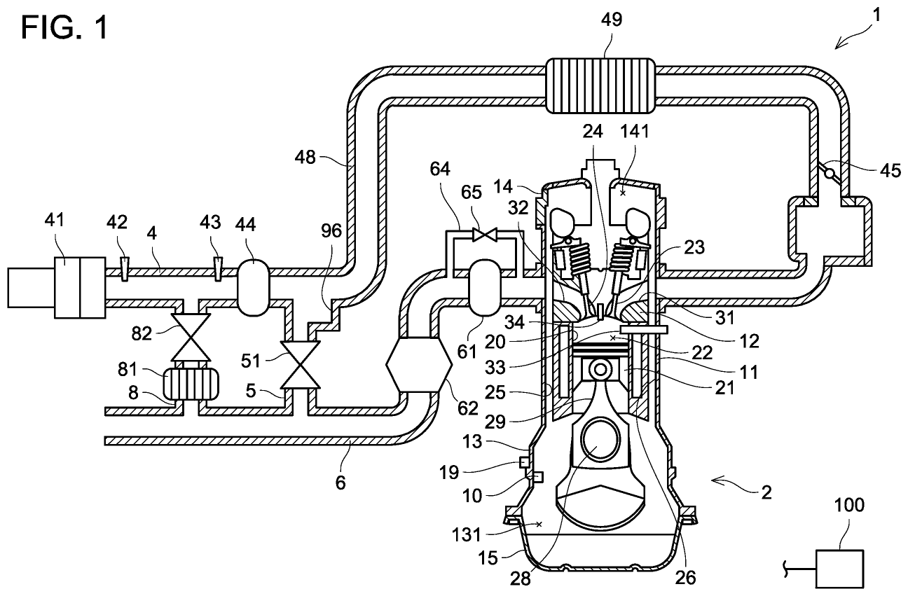

An engine system 1 of an embodiment will be described with reference to the drawings. As shown in FIG. 1, the engine system 1 of the embodiment includes an engine 2, an intake passage 4, an exhaust passage 6, and an ECU (Engine Control Unit) 100. This engine system 1 is installed in a vehicle, for example, a gasoline-powered vehicle.

Firstly, the engine 2 of the engine system 1 will be described. The engine 2 of the engine system 1 is provided with a cylinder block 11, a cylinder head 12, and a crank case 13. The engine 2 is further provided with a head cover 14 and an oil pan 15.

The cylinder block 11 is provided with a plurality of cylinders 20. One cylinder block 11 includes six, eight, or ten cylinders 20, for example. Hereinbelow, one cylinder 20 among the plurality of cylinders 20 will be described.

The cylinder 20 of the cylinder block 11 accommodates a piston 21. A combustion chamber 22 is defined in a portion surrounded by the piston 21 and the cylinder 20. Mixed gas of air and fuel is combusted in the combustion chamber 22. Energy generated by the combustion of the mixed gas reciprocates the piston 21 in the cylinder 20. The piston 21 in the cylinder 20 is connected to a crank shaft 28 via a conrod 29. The crank shaft 28 rotates by reciprocal motion of the piston 21.

The cylinder block 11 of the engine 2 further includes a first communication passage 25 and a second communication passage 26. The cylinder 20, the first communication passage 25, and the second communication passage 26 are arranged laterally next to each other in the cylinder block 11. Further, an injector 33 is fixed to the cylinder block 11. The injector 33 is connected to a fuel tank via a fuel supply passage (both of which are not shown). The injector 33 supplies the combustion chamber 22 of the engine 2 with fuel supplied from the fuel tank. Further, a water temperature sensor 19 is fixed to the cylinder block 11. The water temperature sensor 19 is configured to detect an engine water temperature.

The cylinder head 12 is fixed to an upper part of the cylinder block 11. A spark plug 34 is fixed to the cylinder head 12. The spark plug 34 is configured to ignite the mixed gas of air and fuel present in the combustion chamber 22.

Further, the cylinder head 12 is provided with an intake port 31, a discharge port 32, an intake valve 23, and a discharge valve 24. Each of the intake port 31 and the discharge port 32 is provided at a position communicating with the combustion chamber 22. Air is introduced to the combustion chamber 22 from the intake port 31. Then, exhaust gas, which is generated by combustion of the mixed gas of air and fuel in the combustion chamber 22, is discharged to the discharge port 32 from the combustion chamber 22. The intake valve 23 is configured to open and close the intake port 31. The air is introduced to the combustion chamber 22 when the intake valve 23 opens the intake port 31. The discharge valve 24 is configured to open and close the discharge port 32. The exhaust gas is discharged from the combustion chamber 22 when the discharge valve 24 brings the discharge port 32 to an open state.

The head cover 14 is fixed to an upper part of the cylinder head 12. The head cover 14 covers the cylinder head 12. A gas storage 141 where blowby gas is stored is provided inside the head cover 14.

The crank case 13 is fixed to a lower part of the cylinder block 11. The crank case 13 accommodates the crank shaft 28. The crank case 13 rotatably supports the crank shaft 28. A gas storage 131 where blowby gas is stored is provided inside the crank case 13. The gas storage 131 inside the crank case 13 communicates with the gas storage 141 inside the head cover 14 through the first communication passage 25 and the second communication passage 26 provided in the cylinder block 11.

A pressure sensor 10 is fixed to the crank case 13. The pressure sensor 10 is configured to detect a pressure in the gas storage 131 inside the crank case 13. A detected pressure in the pressure sensor 10 is sent from the pressure sensor 10 to the ECU 100. The oil pan 15 is fixed to a lower part of the crank case 13. The oil pan 15 is configured to store engine oil.

Next, the intake passage 4 of the engine system 1 will be described. The intake passage 4 is connected to the intake port 31 provided in the cylinder head 12 of the engine 2. A downstream end of the intake passage 4 is connected to the intake ports 31. The intake passage 4 is configured to introduce air to the combustion chamber 22 of the engine 2 through the intake port 31. Air flowing through the intake passage 4 is suctioned into the engine 2.

The intake passage 4 is provided with an air cleaner 41, an air flow meter 42 (an example of a flow rate detector), a temperature sensor 43, a compressor 44, an intercooler 49, and a throttle valve 45, in this order from an upstream end of the intake passage 4. Further, the intake passage 4 is provided with a rising portion 48 and a condensed water storage 96.

The air cleaner 41 is arranged at an inlet of the intake passage 4. The air cleaner 41 is configured to remove foreign substances, such as dust, contained in the air to flow through the intake passage 4. The air flow meter 42 is arranged between the air cleaner 41 and the compressor 44. The air flow meter 42 is configured to detect a flow rate of the air flowing through the intake passage 4. The temperature sensor 43 is arranged between the air flow meter 42 and the compressor 44. The temperature sensor 43 is configured to detect a temperature of the air flowing through the intake passage 4.

The compressor 44 is arranged between the air flow meter 42 and the intercooler 49. The compressor 44 is provided with a fan (not shown) and is configured to pump the air by rotating the fan. The compressor 44 pumps the air flowing through the intake passage 4 to a downstream side. The compressor 44 pumps the air to be introduced into the combustion chambers 22 of the engine 2. The compressor 44 configures a supercharger together with a turbine 61, which will be described later.

The intercooler 49 is arranged between the compressor 44 and the throttle valve 45. The intercooler 49 is provided at a position higher than the compressor 44. The intercooler 49 is configured to cool the air and EGR gas flowing through the intake passage 4. Inside the intake passage 4, condensed water may be generated due to the air and the EGR gas flowing through the intake passage 4 being cooled. For example, in a case where a low-load operation continues over a long period of time, condensed water is likely generated in advance of the intercooler 49 because the temperature inside the intake passage 4 is less likely to rise due to a supercharging pressure not being increased and/or a temperature of the EGR gas being low and a flow speed of the air flowing through the intake passage 4 is slow. This phenomenon likely occurs especially in a case of employing a water-cooling intercooler.

The throttle valve 45 is arranged between the intercooler 49 and the engine 2. The throttle valve 45 is configured to adjust a passage area of the intake passage 4. For example, the throttle valve 45 decreases (narrows) the passage area of the intake passage 4. The throttle valve 45 adjusts a flow rate of the air to be introduced to the engine 2 by adjusting the passage area of the intake passage 4.

The rising portion 48 of the intake passage 4 is provided in a portion of the intake passage 4 that is on downstream side relative to the compressor 44 and on upstream side relative to the intercooler 49. The rising portion 48 extends in an up-down direction. The rising portion 48 rises from a compressor 44 side (upstream side) toward the intercooler 49 (downstream side). A downstream end of the rising portion 48 is located at a position higher than an upstream end thereof. Condensed water generated inside the intake passage 4 in a vicinity of the intercooler 49 flows downward within the rising portion 48.

The condensed water storage 96 of the intake passage 4 is provided at a portion of the intake passage 4 that is on the downstream side relative to the compressor 44 and on the upstream side relative to the rising portion 48. The condensed water storage 96 is configured by a recessed portion at a part of the intake passage 4. The condensed water storage 96 is configured to store condensed water. Condensed water generated within the intake passage 4 is stored in the condensed water storage 96.

Next, the exhaust passage 6 of the engine system 1 will be described. The exhaust passage 6 is connected to the discharge port 32 provided in the cylinder head 12 of the engine 2. An upstream end of the exhaust passage 6 is connected to the discharge port 32. Exhaust gas is discharged to the exhaust passage 6 from the combustion chamber 22 of the engine 2 through the discharge port 32. The exhaust gas discharged to the exhaust passage 6 through the discharge port 32 flows through the exhaust passage 6 and is then discharged to outside.

The exhaust passage 6 is provided with the turbine 61 and a catalyst 62, in this order from the upstream end thereof. The turbine 61 is configured to rotate by a pressure of the exhaust gas flowing through the exhaust passage 6. The turbine 61 is coupled to the above-described compressor 44 provided on the intake passage 4. The fan of the compressor 44 rotates by rotation of the turbine 61. The supercharger is configured by the turbine 61 and the compressor 44. The supercharger (the compressor 44 and the turbine 61) is provided across the intake passage 4 and the exhaust passage 6.

The catalyst 62 is configured to clean chemical substances contained in the exhaust gas flowing through the exhaust passage 6. The catalyst 62 may, for example, be a three-way catalyst, and is configured to oxidize or reduce hydrocarbon (HC), carbon oxide (CO), and nitrogen oxide (NOₓ).

An exhaust bypass passage 64 is connected to the exhaust passage 6. The exhaust bypass passage 64 is connected to a portion of the exhaust passage 6 that is on upstream side relative to the turbine 61 and a portion of the exhaust passage 6 that is on downstream side relative to the turbine 61. A part of the exhaust gas flowing through the exhaust passage 6 flows into the exhaust bypass passage 64. The exhaust gas flowing through the exhaust bypass passage 64 bypasses the turbine 61 and flows into the portion of the exhaust passage 6 on the downstream side relative to the turbine 61. A wastegate valve 65 is provided on the exhaust bypass passage 64. The wastegate valve 65 is configured to adjust a flow rate of the exhaust gas flowing through the exhaust bypass passage 64.

The engine system 1 shown in FIG. 1 further includes an exhaust recirculation passage 8 and a drainage passage 5. The exhaust recirculation passage 8 is arranged between the intake passage 4 and the exhaust passage 6. An upstream end of the exhaust recirculation passage 8 is connected to the exhaust passage 6 and a downstream end of the exhaust recirculation passage 8 is connected to the intake passage 4. The upstream end of the exhaust recirculation passage 8 is connected to the portion of the exhaust passage 6 on the downstream side relative to the turbine 61. Thus, the engine system 1 shown in FIG. 1 has an LPL-EGR (Low Pressure Loop-Exhaust Gas Recirculation) configuration. A part of the exhaust gas flowing through the portion of the exhaust passage 6 on the downstream side relative to the turbine 61 flows into the exhaust recirculation passage 8. The downstream end of the exhaust recirculation passage 8 is connected to a portion of the intake passage 4 that is on the upstream side relative to the compressor 44. The exhaust gas that has flowed through the exhaust recirculation passage 8 flows into the portion of the intake passage 4 on the upstream side relative to the compressor 44.

An EGR cooler 81 and an EGR valve 82 are provided on the exhaust recirculation passage 8. The EGR cooler 81 is configured to cool the exhaust gas flowing through the exhaust recirculation passage 8. The EGR valve 82 is configured to adjust a flow rate of the exhaust gas flowing through the exhaust recirculation passage 8.

The drainage passage 5 is arranged between the intake passage 4 and the exhaust passage 6. An upstream end of the drainage passage 5 is connected to the intake passage 4 and a downstream end of the drainage passage 5 is connected to the exhaust passage 6. The drainage passage 5 extends in the up-down direction. The drainage passage 5 extends downward from an intake passage 4 side (upstream side) toward an exhaust passage 6 side (downstream side). The upstream end of the drainage passage 5 is connected to the portion of the intake passage 4 that is on the downstream side relative to the compressor 44 and on the upstream side relative to the intercooler 49. The upstream end of the drainage passage 5 is connected to the portion of the intake passage 4 on the upstream side relative to the rising portion 48. The upstream end of the drainage passage 5 is connected to the condensed water storage 96. The condensed water stored in the condensed water storage 96 flows into the drainage passage 5. The downstream end of the drainage passage 5 is connected to the portion of the exhaust passage 6 on the downstream side relative to the catalyst 62. The condensed water that has flowed through the drainage passage 5 flows into the exhaust passage 6. A drainage valve 51 is provided on the drainage passage 5. The drainage valve 51 is configured to open and close the drainage passage 5.

The ECU 100 (an example of a controller) of the engine system 1 is provided with a CPU and a memory (not shown), for example. The ECU 100 is configured to control operations of respective constituent elements of the engine system 1. Further, the ECU 100 is configured to execute predetermined processes related to the engine system 1. The control and processes executed by the ECU 100 will be described later.

Next, an operation of the engine system 1 will be described. In the above-described engine system 1, the air is introduced to the combustion chamber 22 of the engine 2 through the intake passage 4. Further, the fuel is introduced to the combustion chamber 22 of the engine 2 from the injector 33. When the mixed gas of the air and the fuel introduced into the combustion chamber 22 is combusted, the piston 21 of the engine 2 reciprocates in the cylinder 20. The exhaust gas generated by the combustion of the mixed gas is discharged from the combustion chamber 22 to the exhaust passage 6. The exhaust gas discharged to the exhaust passage 6 is discharged to the outside through the exhaust passage 6. The engine 2 operates as above.

Further, while the exhaust gas discharged from the engine 2 flows through the exhaust passage 6, the turbine 61 provided on the exhaust passage 6 rotates by the pressure of the exhaust gas. When the turbine 61 rotates, the fan of the compressor 44 coupled to the turbine 61 rotates. When the compressor 44 operates as such, the air flowing through the intake passage 4 is pumped to the downstream side.

In the above-described engine system 1, condensed water is generated inside the intake passage 4 when the air and the EGR gas flowing through the intake passage 4 are cooled. The condensed water is likely generated inside the portion of the intake passage 4 especially on the upstream side relative to the intercooler 49. The condensed water generated inside the portion of the intake passage 4 on the upstream side relative to the intercooler 49 flows down through the rising portion 48 of the intake passage 4 and is stored in the condensed water storage 96. The condensed water stored in the condensed water storage 96 flows into the drainage passage 5 connected to the condensed water storage 96. When the drainage valve 51 provided on the drainage passage 5 opens, the condensed water having flowed into the drainage passage 5 flows through the drainage passage 5 and flows into the exhaust passage 6. The condensed water having flowed into the exhaust passage 6 is caused to flow downstream in the exhaust passage 6 by the pressure of the exhaust gas flowing through the exhaust passage 6.

(Condensed Water Discharging Process)

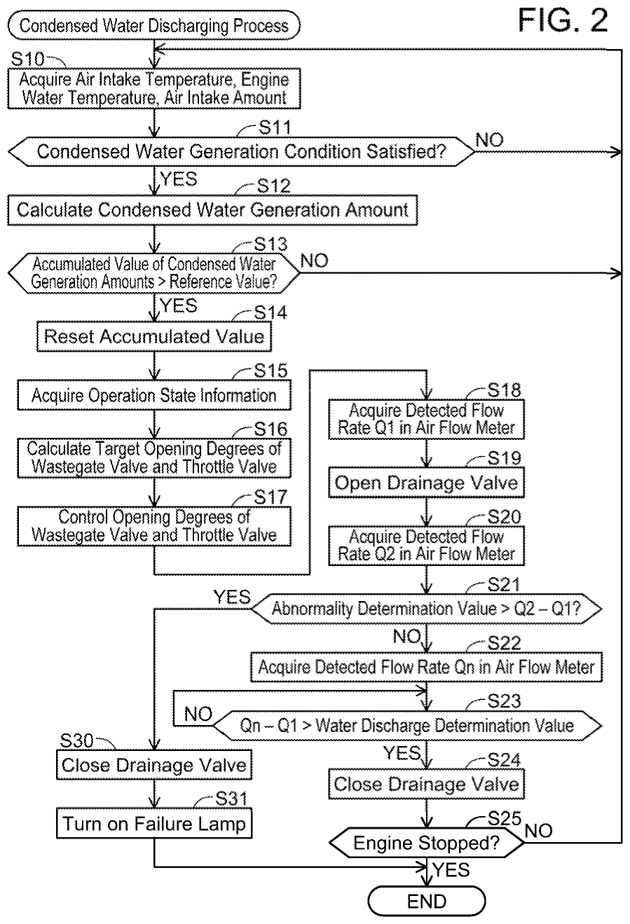

Next, a condensed water discharging process executed in the engine system 1 will be described. The condensed water discharging process is started when the engine 2 of the engine system 1 is started, for example. As shown in FIG. 2, in S10 of the condensed water discharging process, the ECU 100 acquires information on an air intake temperature, an engine water temperature, and an air intake amount in the engine system 1. The air intake temperature of the engine system 1 is detected by the temperature sensor 43 provided on the intake passage 4. The engine water temperature is detected by the water temperature sensor 19 provided in the engine 2. The air intake amount is detected by the air flow meter 42 provided on the intake passage 4.

In the following S11, the ECU 100 determines whether or not a condensed water generation condition is satisfied. The condensed water generation condition is set, for example, based on the air intake temperature, the engine water temperature, and the air intake amount of the engine system 1. For example, in a case where the engine water temperature is low, in a case where the air intake temperature is low, and/or in a case where the air intake amount is large, condensed water is likely generated, thus the condensed water generation condition is likely to be satisfied. On the other hand, in a case where the engine water temperature is high, in a case where the air intake temperature is high, and/or in a case where the air intake amount is small, condensed water is less likely generated, thus the condensed water generation condition is less likely to be satisfied. In a case where the condensed water generation condition is satisfied, the ECU 100 determines YES in S11 and proceeds to S12. In a case where the condensed water generation condition is not satisfied, the ECU 100 determines NO in S11 and returns to S10.

In the following S12, the ECU 100 calculates a condensed water generation amount. For example, the ECU 100 estimates a pre-confluence moisture percentage based on the detected flow rate in the air flow meter 42. The pre-confluence moisture percentage is a percentage of moisture contained in the air before confluence of the air flowing through the intake passage 4 and the exhaust gas flowing through the exhaust recirculation passage 8. Further, the ECU 100 estimates a post-confluence moisture percentage based on the detected temperature in the temperature sensor 43. The post-confluence moisture percentage is a percentage of moisture contained in the gas after the confluence of the air flowing through the intake passage 4 and the exhaust gas flowing through the exhaust recirculation passage 8. Then, the ECU 100 estimates a condensed water generation amount based on a difference between the post-confluence moisture percentage and the pre-confluence moisture percentage. Further, the ECU 100 corrects the estimated condensed water generation amount based on the detected temperature in the water temperature sensor 19. As above, the ECU 100 calculates the condensed water generation amount. Further, the ECU 100 accumulates calculated condensed water generation amounts over a predetermined time period.

In the following S13, the ECU 100 determines whether or not an accumulated value of the condensed water generation amounts is greater than a reference value. In a case where the accumulated value is greater than the reference value, the ECU 100 determines YES in S13 and proceeds to S14. In a case where the accumulated value is not greater than the reference value, the ECU 100 determines NO in S13 and returns to S10.

In the following S14, the ECU 100 resets the accumulated value of the condensed water generation amounts. In the following S15, the ECU 100 acquires operation state information. For example, the ECU 100 acquires information on a rotation speed of the crank shaft 28 and information on the opening degree of the throttle valve 45. In the following S16, the ECU 100 calculates a target opening degree of the wastegate valve 65 provided on the exhaust bypass passage 64. The ECU 100 further calculates a target opening degree of the throttle valve 45 provided on the intake passage 4.

In the following S17, the ECU 100 controls the wastegate valve 65 so that the opening degree of the wastegate valve 65 becomes the target opening degree calculated in S16 above. The ECU 100 reduces the opening degree of the wastegate valve 65. The ECU 100 may fully close the wastegate valve 65. Further, the ECU 100 controls the throttle valve 45 so that the opening degree of the throttle valve 45 becomes the target opening degree calculated in S16 above. The ECU 100 reduces the opening degree of the throttle valve 45.

When the opening degree of the wastegate valve 65 is reduced, the flow rate of the exhaust gas flowing through the exhaust bypass passage 64 decreases. In this case, the flow rate of the exhaust gas flowing into the exhaust bypass passage 64 from the exhaust passage 6 decreases, whereas the flow rate of the exhaust gas passing through the turbine 61 provided on the exhaust passage 6 increases. As a result, the pressure of the exhaust gas that causes the turbine 61 to rotate increases, and the pressure with which the compressor 44 coupled to the turbine 61 pumps the air increases.

Further, when the opening degree of the throttle valve 45 is reduced in a state where the pressure in the compressor 44 is increased, a pressure inside a portion of the intake passage 4 that is on the downstream side relative to the compressor 44 and on the upstream side relative to the throttle valve 45 increases. Further, a pressure inside the drainage passage 5 connected to the intake passage 4 also increases.

In the following S18, the ECU 100 acquires a detected flow rate Q1 in the air flow meter 42. The detected flow rate Q1 is a flow rate of the air flowing through the intake passage 4 when the drainage valve 51 provided on the drainage passage 5 is closed (before the drainage valve 51 is opened).

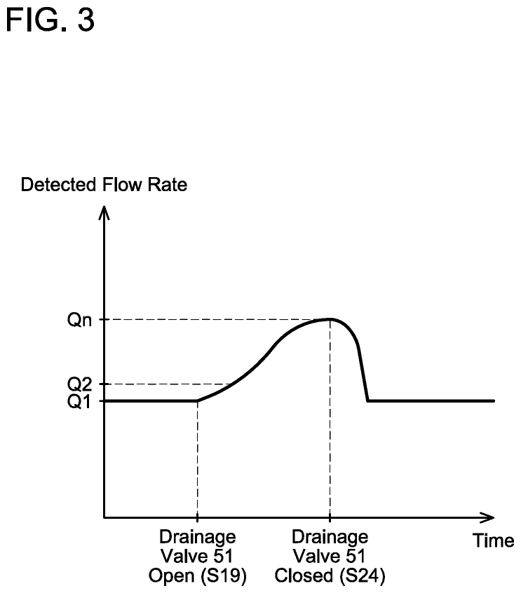

In the following S19, the ECU 100 opens the drainage valve 51 provided on the drainage passage 5. When the drainage valve 51 is opened, the intake passage 4 communicates with the exhaust passage 6 via the drainage passage 5, and a part of the air flowing through the intake passage 4 flows into the exhaust passage 6 through the drainage passage 5. Due to this, the flow rate of the air flowing through the intake passage 4 increases, and the detected flow rate in the air flow meter 42 increases as shown in FIG. 3. Further, when the drainage valve 51 is opened, the condensed water flows into the exhaust passage 6 through the drainage passage 5. Since the pressure inside the drainage passage 5 has been increased by the process of S17 above, the condensed water is pushed out to the exhaust passage 6 by the increased pressure.

In the following S20, the ECU 100 acquires a detected flow rate Q2 in the air flow meter 42. The detected flow rate Q2 is the flow rate of the air flowing through the intake passage 4 after the drainage valve 51 has been opened.

In the following S21, the ECU 100 determines whether or not a difference between the detected flow rate Q2 acquired in S20 above and the detected flow rate Q1 acquired in S18 above is smaller than a predetermined abnormality determination value. That is, the ECU 100 determines whether or not an inequality of the abnormality determination value >Q2-Q1 is satisfied. In a case where a difference between Q2 and Q1 is smaller than the abnormality determination value, the ECU 100 determines YES in S21 and proceeds to S30. In a case where the difference is not smaller than the abnormality determination value, the ECU 100 determines NO in S21 and proceeds to S22.

In S30 after determination of YES in S21, the ECU 100 closes the drainage valve 51. In the following S31, the ECU 100 turns on a failure lamp (not shown) of the engine system 1. When completing the process of S31, the ECU 100 terminates the condensed water discharging process.

On the other hand, in S22 after determination of NO in S21, the ECU 100 acquires a detected flow rate Qn in the air flow meter 42. The detected flow rate Qn is the current flow rate of the air flowing through the intake passage 4. The detected flow rate Qn is a flow rate when the drainage valve 51 provided in the drainage passage 5 is open.

In the following S23, the ECU 100 determines whether or not a difference between the detected flow rate Qn acquired in S22 above and the detected flow rate Q1 acquired in S18 is greater than a predetermined water discharge determination value. That is, the ECU 100 determines whether or not an inequality of Qn−Q1>the water discharge determination value is satisfied. In a case where the difference between Qn and Q1 is greater than the water discharge determination value, the ECU 100 determines YES in S23 and proceeds to S24. In a case where the difference is not greater than the water discharge determination value, the ECU 100 determines NO in S23 and repeats the process of S23. In the case of YES in S23, it can be determined that the condensed water generated in the intake passage 4 has been discharged through the drainage passage 5. Thus, in the case of YES in S23, it can be determined that a timing to close the drainage valve 51 provided on the drainage passage 5 has come. On the other hand, in the case of NO in S23, it can be determined that the condensed water has not yet been discharged. Thus, in the case of NO in S23, it can be determined that the timing to close the drainage valve 51 has not yet come.

In the following S24, the ECU 100 closes the drainage valve 51. When the drainage valve 51 is closed, the intake passage 4 no longer communicates with the exhaust passage 6 via the drainage passage 5, and the air flowing through the intake passage 4 stops flowing into the exhaust passage 6. Due to this, the flow rate of the air flowing through the intake passage 4 decreases, and the detected flow rate in the air flow meter 42 decreases as shown in FIG. 3. Further, in S24, the ECU 100 may open the wastegate valve 65 provided on the exhaust bypass passage 64.

In the following S25, the ECU 100 determines whether or not the engine 2 of the engine system 1 has stopped. In a case where the engine 2 has stopped, the ECU 100 determines YES in S25 and terminates the condensed water discharging process. In a case where the engine 2 has not stopped, the ECU 100 determines NO in S25 and returns to S10.

The engine system 1 of the embodiment has been described above. As apparent from the foregoing description, the engine system 1 includes the engine 2, the intake passage 4 through which the air to be suctioned into the engine 2 flows, the exhaust passage 6 through which the gas discharged from the engine 2 flows, and the supercharger (the compressor 44 and the turbine 61) provided across the intake passage 4 and the exhaust passage 6. In the supercharger, the turbine 61 is operated by the pressure of the gas flowing through the exhaust passage 6, by which the compressor 44 pumps the air flowing through the intake passage 4 to the engine 2. Further, the engine system 1 includes the exhaust recirculation passage 8 connected to the intake passage 4 and the portion of the exhaust passage 6 on the downstream side relative to the turbine 61, the throttle valve 45 provided in the portion of the intake passage 4 on the downstream side relative to the compressor 44, the drainage passage 5 connected to the portion of the intake passage 4 on the downstream side relative to the compressor 44 and on the upstream side relative to the throttle valve 45, and the drainage valve 51 configured to open and close the drainage passage 5. The exhaust recirculation passage 8 feeds to the intake passage 4 the exhaust gas flowing in the portion of the exhaust passage 6 on the downstream side relative to the turbine 61. The throttle valve 45 is configured to adjust the passage area of the portion of the intake passage 4 on the downstream side relative to the compressor 44. Further, the engine system 1 includes the exhaust bypass passage 64 connected to the portion of the exhaust passage 6 on the upstream side relative to the turbine 61 and the portion thereof on the downstream side relative to the turbine 61, and the wastegate valve 65 configured to adjust the passage area of the exhaust bypass passage 64. The exhaust bypass passage 64 feeds the exhaust gas flowing in the portion of the exhaust passage 6 on the upstream side relative to the turbine 61 to the portion thereof on the downstream side relative to the turbine 61. The ECU 100 of the engine system 1 is configured to reduce the opening degree of the wastegate valve 65 and reduce the opening degree of the throttle valve 45 (see S17 of FIG. 2).

In the above engine system 1, the air and EGR gas flowing through the intake passage 4 are cooled, for example, by the intercooler 49, which may generate condensed water inside the intake passage 4. In the above-described configuration, the flow rate of the exhaust gas flowing through the exhaust bypass passage 64 decreases by the ECU 100 reducing the opening degree of the wastegate valve 65. In this case, the flow rate of the exhaust gas flowing into the exhaust bypass passage 64 from the exhaust passage 6 decreases, whereas the flow rate of the exhaust gas passing through the turbine 61 provided on the exhaust passage 6 increases. As a result, the pressure of the exhaust gas that causes the turbine 61 to operate increases, and the pressure with which the compressor 44 pumps the air flowing through the intake passage 4 increases.

Since the above-described configuration is the LPL-EGR configuration in which the exhaust recirculation passage 8 is connected to the portion of the exhaust passage 6 on the downstream side relative to the turbine 61, the flow rate of the exhaust gas passing through the turbine 61 increases. Due to this, the pressure of the exhaust gas passing through the turbine 61 can sufficiently operate the turbine 61, thus the compressor 44 does not need to be electrically driven. Therefore, extra power for driving the compressor 44 is not consumed.

Further, in the above-described configuration, the pressure in the portion of the intake passage 4 on the downstream side relative to the compressor 44 and on the upstream side relative to the throttle valve 45 increases by the ECU 100 reducing the opening degree of the throttle valve 45. In this case, the pressure in the drainage passage 5 connected to the portion of the intake passage 4 on the downstream side relative to the compressor 44 and on the upstream side relative to the throttle valve 45 increases. Due to this, the condensed water generated in the intake passage 4 is discharged through the drainage passage 5 by the increased pressure. Thus, according to the above configuration, the condensed water can be discharged without increasing power consumption.

Further, in the LPL-EGR configuration, the temperature of the exhaust gas fed from the exhaust passage 6 to the intake passage 4 through the exhaust recirculation passage 8 is low as compared to a conventional HPL-EGR configuration, thus a large amount of condensed water may be generated in the intake passage 4. In this case, the above configuration, which is capable of discharging the condensed water without increasing power consumption, is particularly effective.

Further, in the above-described configuration, the timing to close the drainage valve 51 can be determined based on the detected flow rate in the air flow meter 42 (see S23, S24 of FIG. 2). Further, whether or not the condensed water generated in the intake passage 4 has been discharged through the drainage passage 5 can be determined based on the detected flow rate in the air flow meter 42.

Further, in the above-described configuration, the drainage passage 5 is connected to the portion of the intake passage 4 on the downstream side relative to the compressor 44 and on the upstream side relative to the intercooler 49. Since hot air and EGR gas fed to the intake passage 4 are rapidly cooled in advance of the intercooler 49, condensed water may be generated in a large amount in the portion of the intake passage 4 on the upstream side relative to the intercooler 49. As a result, the condensed water may collect in the portion of the intake passage 4 on the upstream side relative to the intercooler 49. According to the above-described configuration, the condensed water collecting in the portion of the intake passage 4 on the upstream side relative to the intercooler 49 can be discharged through the drainage passage 5.

Further, in the above-described configuration, the intake passage 4 includes the rising portion 48 that rises from the compressor 44 side toward the intercooler 49 side at the portion of the intake passage 4 on the downstream side relative to the compressor 44 and on the upstream side relative to the intercooler 49. Further, the drainage passage 5 is connected to the portion of the intake passage 4 on the upstream side relative to the rising portion 48. According to this configuration, the condensed water generated in the portion of the intake passage 4 on the upstream side relative to the intercooler 49 flows down through the rising portion 48 and collects in the portion of the intake passage 4 on the upstream side relative to the rising portion 48. The condensed water collecting on the upstream side relative to the rising portion 48 can be discharged through the drainage passage 5.

One embodiment has been described above, however, specific aspects of the disclosure herein are not limited to the embodiment. In the following description, configurations that are the same as those in the foregoing description will be given the same reference signs, and explanations for the configurations will be omitted.

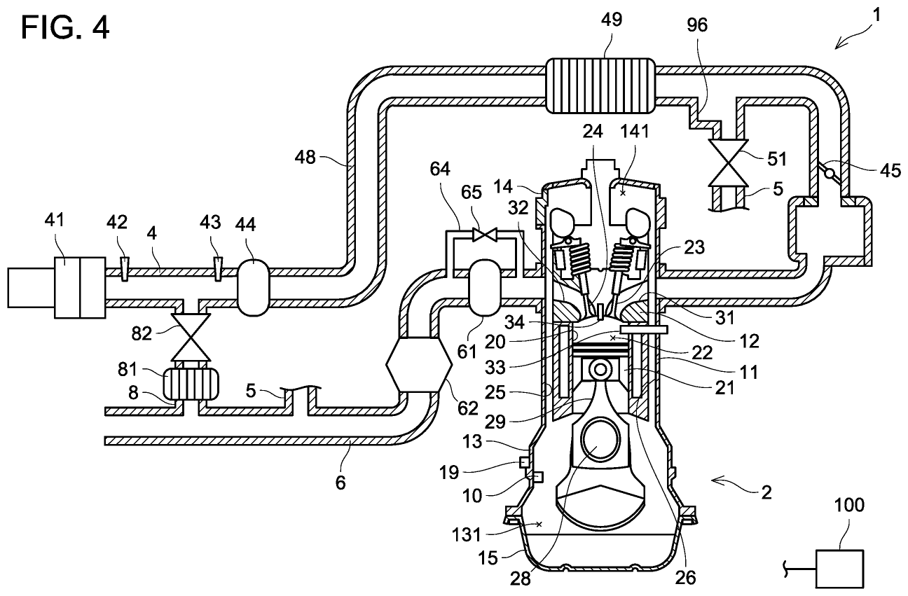

In the above embodiment, the drainage passage 5 is connected to the portion of the intake passage 4 on the downstream side relative to the compressor 44 and on the upstream side relative to the intercooler 49, however, no limitation is placed to this configuration. In another embodiment, as shown in FIG. 4, the upstream end of the drainage passage 5 may be connected to a portion of the intake passage 4 that is on the downstream side relative to the intercooler 49 and on the upstream side relative to the throttle valve 45. The downstream end of the drainage passage 5 is connected to the exhaust passage 6. Further, the condensed water storage 96 may be provided in the portion of the intake passage 4 on the downstream side relative to the intercooler 49 and on the upstream side relative to the throttle valve 45.

The air and EGR gas flowing through the intake passage 4 are cooled by the intercooler 49, which may result in generation of a large amount of condensed water in the portion of the intake passage 4 on the downstream side relative to the intercooler 49. Especially in a case of an air-cooling intercooler, overcooling may occur in the intercooler 49 depending on the operating state. According to the above-described configuration, the condensed water collecting in the portion of the intake passage 4 on the downstream side relative to the intercooler 49 can be discharged.

(Corresponding Relationships)

The portion of the exhaust passage 6 on the downstream side relative to the supercharger is an example of “first portion of the exhaust passage”. The portion of the intake passage 4 on the downstream side relative to the supercharger is an example of “second portion of the intake passage”. The portion of the intake passage 4 on the downstream side relative to the supercharger and on the upstream side relative to the throttle valve 45 is an example of “third portion of the intake passage”. The portion of the exhaust passage 6 on the upstream side relative to the supercharger is an example of “fourth portion of the exhaust passage”.

What is claimed is:

1. An engine system comprising:
an engine;
an intake passage through which air to be suctioned into the engine flows;
an exhaust passage through which gas discharged from the engine flows;
a supercharger provided across the intake passage and the exhaust passage, and configured to be operated by a pressure of gas flowing through the exhaust passage to pump air flowing through the intake passage to the engine;
an exhaust recirculation passage connected to the intake passage and a first portion of the exhaust passage that is on downstream side relative to the supercharger, and provided to feed gas flowing in the first portion of the exhaust passage to the intake passage;
a throttle valve provided in a second portion of the intake passage on downstream side relative to the supercharger, and configured to adjust a passage area of the second portion of the intake passage;
a drainage passage connected to a third portion of the intake passage that is on the downstream side relative to the supercharger and on upstream side relative to the throttle valve;
a drainage valve configured to open and close the drainage passage;
an exhaust bypass passage connected to the first portion of the exhaust passage and a fourth portion of the exhaust passage that is on upstream side relative to the supercharger, and provided to feed gas flowing in the fourth portion of the exhaust passage to the first portion of the exhaust passage;
a wastegate valve configured to adjust a passage area of the exhaust bypass passage; and
a controller,
wherein
the controller is configured to reduce an opening degree of the wastegate valve, reduce an opening degree of the throttle valve, and open the drainage valve.

2. The engine system according to claim 1, further comprising:
a flow rate detector configured to detect a flow rate of air flowing through the intake passage,
wherein the controller is configured to determine a timing to close the drainage valve and determine whether condensed water generated in the intake passage has been discharged through the drainage passage, based on the flow rate detected by the flow rate detector.

3. The engine system according to claim 1, further comprising:
an intercooler provided on the third portion of the intake passage,
wherein the drainage passage is connected to a portion of the intake passage that is on the downstream side relative to the supercharger and on upstream side relative to the intercooler.

4. The engine system according to claim 3, wherein
the intercooler is provided at a position higher than a position of the supercharger,
the intake passage comprises a rising portion at the portion thereof that is on the downstream side relative to the supercharger and on the upstream side relative to the intercooler, the rising portion rising from a supercharger side to an intercooler side, and
the drainage passage is connected to a portion of the intake passage on upstream side relative to the rising portion.

5. The engine system according to claim 1, further comprising:
an intercooler provided on the third portion of the intake passage,
wherein the drainage passage is connected to a portion of the intake passage that is on downstream side relative to the intercooler and on the upstream side relative to the throttle valve.
